(19) United States
(12) Patent Application Publication
(10) Pub. No.: US 2009/0140940 A1
(43) Pub. Date: Jun. 4, 2009

(54) Vehicle antenna

(76) Inventor: Clayton T. Giesbrecht, Palm Bay, FL (US)

Correspondence Address: Clayton Travis Giesbrecht, 544 Anaconda Dr., Colorado Springs, CO, 80919, US

(21) Appl. No.: 11/999,243

(22) Filed: Dec. 4, 2007

(51) Int. Cl. G09F 17/00; H01Q 1/32

(52) U.S. Cl. 343/715; 116/173

(57) ABSTRACT

A vehicle antenna comprises a mast having proximal and distal portions, the proximal portion attached to the vehicle. A terminating member is provided at the distal portion of the mast and a first connector is affixed thereto. The first connector has a body formed to encompass the terminating member and an adjacent section of the mast and includes an eyelet projecting therefrom. Additionally, a decorative antenna kit comprises a first connector for encompassing a terminating member of an antenna mast and includes an eyelet projecting therefrom. Means are supplied for fixing the first connector to the mast. A second connector projects through the eyelet; the second connector having a first end and a second end, the first end being affixed to the first connector and the second end terminating in means for attaching an indicia device. A plurality of secondary eyelets and means for attaching the secondary eyelets to the mast is also provided.

### TECHNICAL FIELD

This invention relates generally to vehicle antennas and more particularly to such antennas modified to imitate a fishing pole. Still more particularly, it relates to a kit for achieving the desired imitation on an existing antenna.

### BACKGROUND ART

The ubiquity of fishing as a hobby (i.e., sport fishing as opposed to commercial fishing) is well known. Devotees have often gone to considerable lengths to advertise their love of the sport. One of the ways in which this has been accomplished has been the utilization of a vehicle antenna to either simulate a fishing pole, for example as shown in U.S. Des. Pat. No. 454,863; or to use a fishing pole as a vehicle antenna, as shown in U.S. Pat. No. 6,378,239. While these devices provide useful constructions, it would be an advance in art to provide a more “do-it-yourself” simulation that would allow also the depiction of a particular type of sport fishing, e.g., a practitioner could be depicted as a trout fisherperson or a bass fisherperson.

### DISCLOSURE OF INVENTION

It is, therefore, an object of the invention to obviate the disadvantages of the prior art.

It is another object of the invention to enhance displays.

Yet another object of the invention is the improvement of displays, particularly those displays involving a vehicle antenna.

These objects are accomplished, in one aspect of the invention, by the provision of a vehicle antenna comprising: a mast having proximal and distal portions, the proximal portion attached to the vehicle; a terminating member at the distal portion; and a first connector affixed to the terminating member, the first connector comprising a body formed to encompass the terminating member and an adjacent section of the mast and including an eyelet projecting therefrom.

The objects are further accomplished by the provision of a decorative antenna kit comprising: a first connector for encompassing a terminating member of an antenna mast, the first connector comprising a body formed to encompass the terminating member and an adjacent section of the mast and including an eyelet projecting therefrom; and means for fixing the first connector to the mast.

In a preferred embodiment of the invention, a second connector projects through the eyelet, the second connector having first end connected to the first connector and a second end that can terminate a windsock. The windsock itself can be in the form of an identifiable fish, for example.

### BRIEF DESCRIPTION OF THE DRAWINGS

FIG. 1 is an elevation view, partially in section, illustrating an embodiment of the invention;

FIG. 2 is top view of an embodiment of the invention, taken along the line 2-2 of FIG. 1 and with parts omitted for clarity;

FIG. 3 is an elevation view of an alternate embodiment of the invention;

FIG. 4 is a diagrammatic view of a kit in accordance with an embodiment of the invention;

FIG. 5 is an enlarged detail of a connector according to an embodiment of the invention.

FIG. 6 is an elevation view of an alternate embodiment of the invention; and

FIG. 7 is a perspective view of an eyelet that can be employed with the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

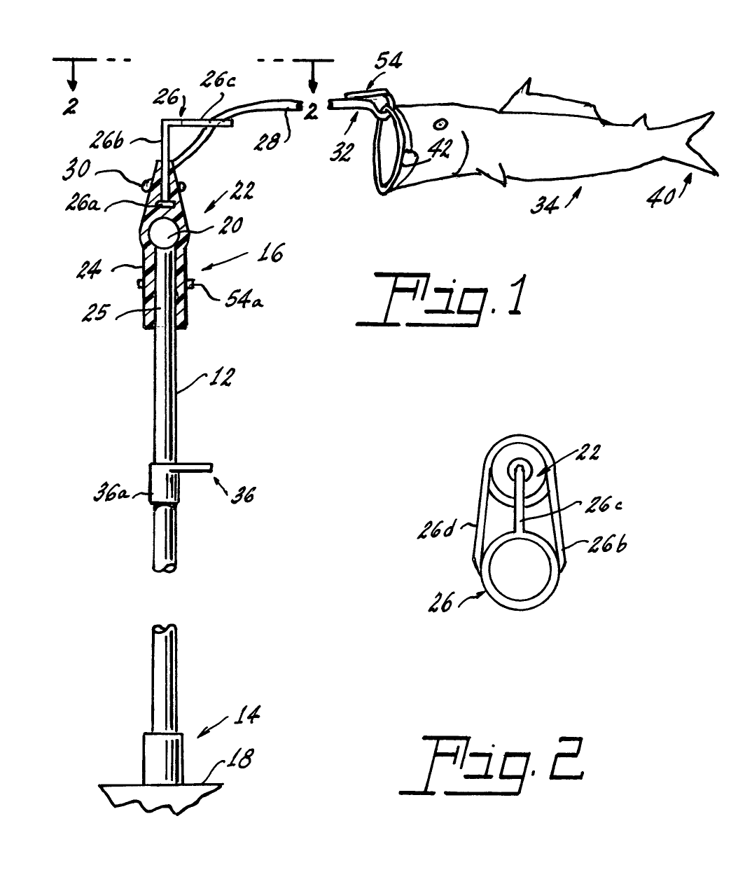

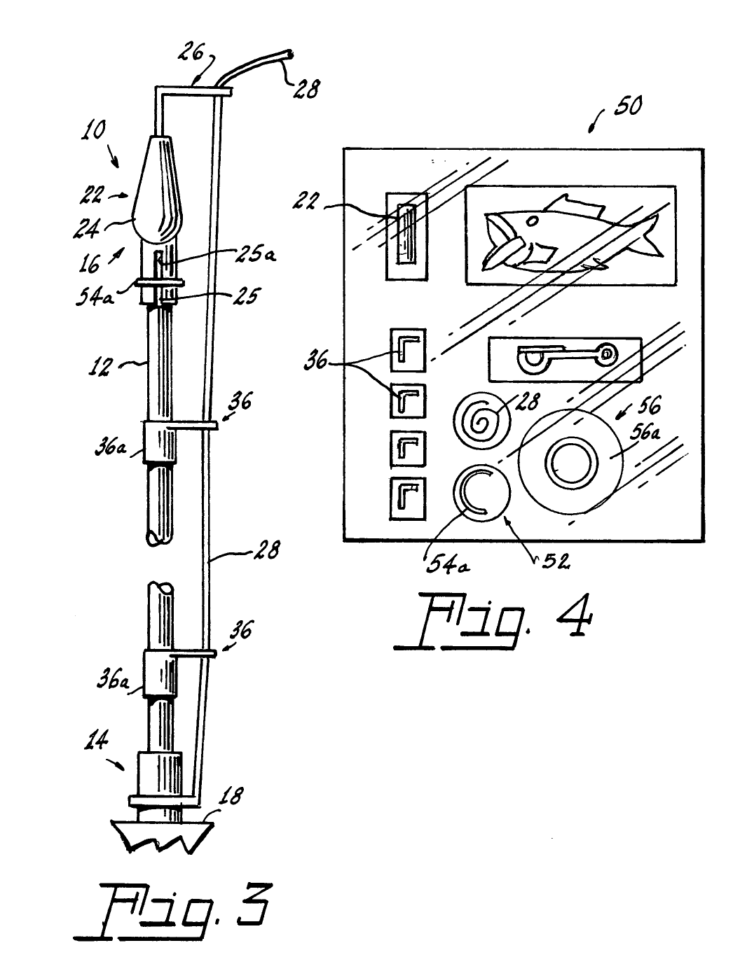

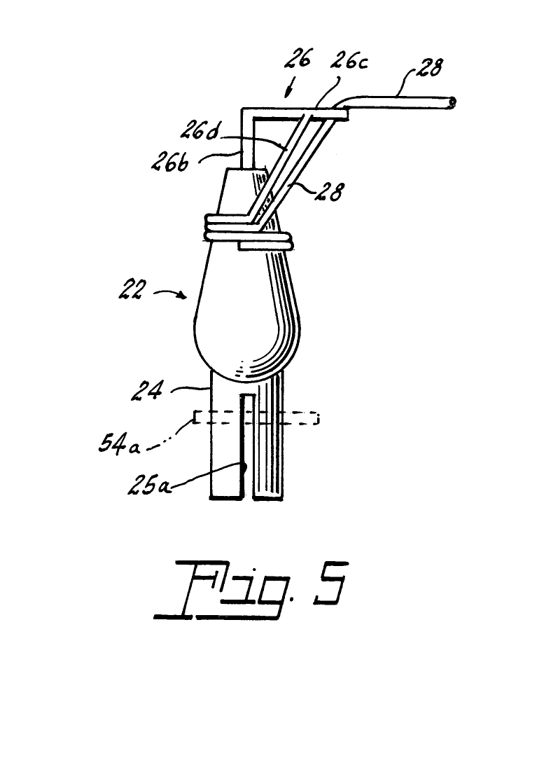

Referring now to the drawings with greater particularity, there is shown in FIG. 1 a vehicle antenna 10 comprising a mast 12 having proximal and distal portions 14, 16, respectively. The proximal portion 14 is attached to a vehicle 18. A terminating member 20, usually in the form of a sphere, is provided at the distal portion 16. A first connector 22 is affixed to the terminating member, the first connector comprising a body 24 formed to encompass the terminating member 20 and an adjacent section 25 of the mast 12. The first connector 22 includes an eyelet 26 projecting therefrom. The first connector 22 is formed from a flexible material, such as rubber or silicone and includes at least one and preferably two expansions slots 25a (FIG. 5) located 180° apart. Only one such slot is shown in the figures. The eyelet 26 can be “L” shaped having a first leg 26b and an orthogonal leg 26c and be provided with a flange or disk 26a that that has been overmolded into the body 24, as shown in FIG. 1. Additionally, supports 26d, shown in FIGS. 2 and 5, can be utilized

A second connector 28 projects through the eyelet 26 and has a first end 30 and a second end 32. The first end 30, in a preferred embodiment, is affixed to the first connector 22 and the second end 32 terminates in a windsock 34, which can be in the form of an imaginary fish or a replica of a real fish, such as a trout, bass, for example. Additionally, the fish can take the form of a religious symbol, such as an Ichthus.

Affixation of the first end 30 can be by any suitable technique, such as a wire wrap. Also, the first end, too, could be overmolded into the body 24 of the first connector 22.

To simulate the fishing pole even more completely, the mast 12 has a plurality of secondary eyelets 36 affixed thereto. While these secondary eyelets can be permanently installed, as by soldering, it is preferred that they be removable, as by taping a split or half-round barrel 36a to the mast 12.

In an alternate embodiment of the invention, the second end 32 of the second connector 28 is affixed to the proximal portion 14 of the mast 12. In this event, the second connector can comprise a length of monofilament fishing line that is threaded through the eyelets 36 up through eyelet 26 and thence to its termination.

If it is desired that the system be capable of displaying more than one kind of fish (or other indicia), the second end 32 of the second connector 28 can be provided with indicia attaching means 54, which can be in the form of a typical fishing line safety pin, as shown in FIG. 1. Additionally, a cinch tie 54a can encircle the body 24 to further secure the connector 22 to the mast 12.

Where the windsock or indicia takes the form of a fish, it is preferable the fish have a mouth end 38 and a tail end 40 and that the mouth end comprises a rubber frame 42 to aid in absorbing any shocks generated by the air movement caused by a moving vehicle.

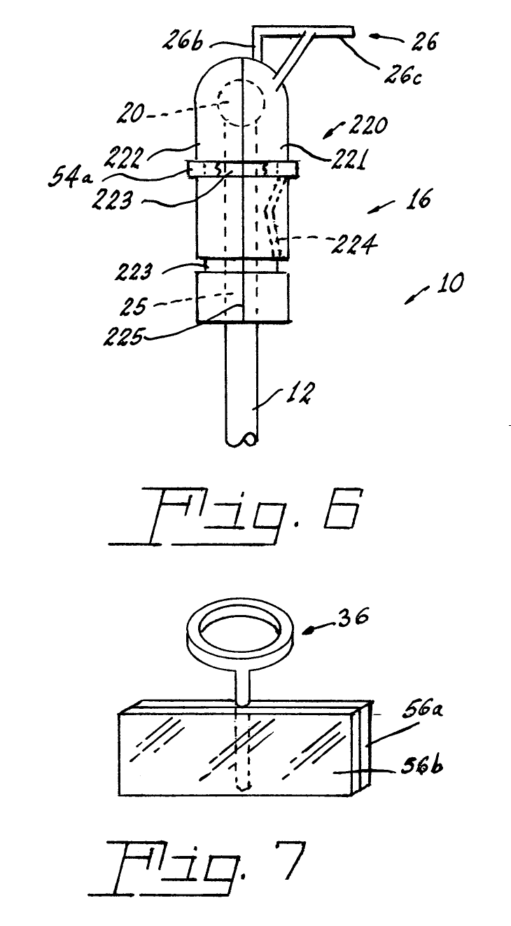

An alternate embodiment of the invention is shown in FIG. 6 wherein a first connector 220 is comprised of two halves, 221, 222, separable along a longitudinal line 225. Because the connector 220 is formed in two pieces, a rigid material such as a hard plastic, hard rubber or even a metal, such, for example, as cast aluminum can be used. In such a situation the eyelet 26 can be integrally formed with the half 221. Orthogonal grooves 223 are provided to accept cinching ties 54a, one of which is partially shown in FIG. 6. A more or less longitudinal opening 224 is formed in the first half 221, between the grooves 223, to accept a second connector 28. The cinch ties 54a, when applied, hold the second connector in place.

While the antenna just described can be provided as a completed end-user replacement antenna, the same results can be achieved by a do-it-yourselfer with a kit.

In this regard, a decorative antenna kit 50 is shown diagrammatically in FIG. 5. Therein the kit 50 comprises: a first connector 22 or 220 for encompassing a terminating member 20 of an antenna mast 12. The kit 50 further includes means 52 for attaching and fixing the connector 22 or 220 to the mast 12. While the means 52 can take many forms, cinch ties 54a are a preferred means. They are reasonably inexpensive and easy to employ, usually requiring only finger action to provide a tight enclosure and adequate securement.

In the kit version it would be a definite advantage for the second end 32 of the second connector 28 to be provided with a safety pin so that the indicia 34a could be changed as desired. Many types of indicia 34a could be provided as well as a plurality of secondary eyelets 36 and means 56 for attaching the secondary eyelets to the mast, for example, a roll of suitable tape 56a. Alternatively, pre-taped eyelets 36 can be provided, as shown in FIG. 7 with the adhesive portion of the tape covered by releasable protector 56b.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A vehicle antenna comprising:
a mast having proximal and distal portions, said proximal portion attached to said vehicle;
a terminating member at said distal portion; and
a first connector affixed to said terminating member, said first connector comprising a body formed to encompass said terminating member and an adjacent section of said mast and including an eyelet projecting therefrom.

2. The vehicle antenna of claim 1 wherein a second connector projects through said eyelet.

3. The vehicle antenna of claim 2 wherein said second connector has a first end and a second end, said first end being affixed to said first connector and said second end terminating in a windsock.

4. The vehicle antenna of claim 3 wherein said windsock has the form of a fish.

5. The vehicle antenna of claim 4 wherein mast said has a plurality of secondary eyelets affixed thereto.

6. The vehicle antenna of claim 5 wherein said secondary eyelets are substantially evenly spaced.

7. The vehicle antenna of claim 2 wherein said second connector is affixed to said first connector.

8. The vehicle antenna of claim 2 wherein said second connector is affixed to said proximal portion.

9. The vehicle antennal of claim 3 wherein said windsock has a mouth end and a tail end and said mouth end comprises a rubber flame.

10. A decorative antenna kit comprising:
a first connector for encompassing a terminating member of an antenna mast, said first connector comprising a body formed to encompass said terminating member and an adjacent section of said mast and including an eyelet projecting therefrom; and
means for fixing said first connector to said mast.

11. The decorative antenna kit of claim 10 wherein a second connector projects through said eyelet.

12. The decorative antenna kit of claim 11 wherein said second connector has a first end and a second end, said first end being affixed to said first connector and said second end terminating in an indicia device.

13. The decorative antenna kit of claim 12 wherein said indicia device comprises a windsock in a fish-like configuration.

14. The decorative antenna kit of claim 13 wherein said kit includes a plurality of secondary eyelets and means for attaching said secondary eyelets to said mast.

15. The vehicle antenna of claim 1 wherein said first connector comprises a two-half body separated along a longitudinal line.

16. The vehicle antenna of claim 15 wherein said eyelet is integrally formed with a first of said halves.
